(19) United States
(12) Patent Application Publication
(10) Pub. No.: US 2021/0300372 A1
(43) Pub. Date: Sep. 30, 2021

(54) DRIVING ASSISTANT METHOD, VEHICLE-MOUNTED DEVICE AND READABLE STORAGE MEDIUM

(71) Applicant: Mobile Drive Technology Co.,Ltd., New Taipei (TW)

(72) Inventors: HSIEN-CHI TSAI, New Taipei (TW); CHUN-YU CHEN, New Taipei (TW)

(21) Appl. No.: 17/022,349

(22) Filed: Sep. 16, 2020

(30) Foreign Application Priority Data
Mar. 24, 2020 (CN) 202010215205.7

(51) Int. Cl. B60W 30/18; G08G 1/16; B60W 40/04; B60W 30/095; B60W 40/105

(52) U.S. Cl. CPC B60W 30/18163; G08G 1/167; B60W 40/04; B60W 30/0956; B60W 40/105; B60W 2520/10; B60W 2554/4041; B60W 2420/42; B60W 2554/4044; B60W 2554/80; B60W 2552/53

(57) ABSTRACT

An driving assistant method is provided. The method includes identifying a type of a traffic line between a current lane in which a vehicle is located and an adjacent lane of the current lane. The type of the traffic line is used to determine whether or not the adjacent lane is an overtaking lane. An overtaking speed of the vehicle is calculated when the vehicle can overtake from the current lane to the adjacent lane. A prompt including the overtaking speed is issued once the overtaking speed is obtained.

### FIELD

The present disclosure relates to driving safety control technology, in particular to a driving assistant method, a vehicle-mounted device, and a readable storage medium.

### BACKGROUND

Vehicles are essential tools for people's lives. Overtaking is a high-risk driving behavior. Generally, different drivers have different driving experiences, and it is not easy for a driver to pay attention to all nearby vehicles at the same time. Therefore, it is risky for a driver to judge whether overtaking another vehicle can be successful based on the driving experience. In particular, it is more difficult for the driver to estimate whether overtaking another vehicle can be successful when the vehicles are driven on a single carriageway road having only two lanes.

### BRIEF DESCRIPTION OF THE DRAWINGS

FIG. 1 illustrates a schematic diagram of a vehicle-mounted device of the present disclosure.

FIG. 2 shows one embodiment of modules of a driving assistant system of the present disclosure.

FIG. 3 shows a flow chart of one embodiment of a driving assistant method of the present disclosure.

FIG. 4 illustrates a traffic line between a lane in which a vehicle currently located and an adjacent lane.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

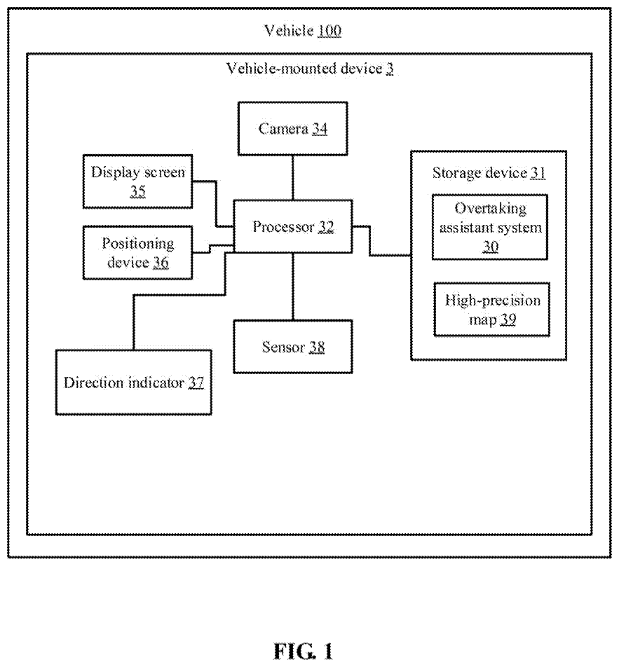

FIG. 1 illustrates a schematic diagram of a vehicle-mounted device 3 of the present disclosure.

In at least one embodiment, the vehicle-mounted device 3 is installed on a vehicle 100. The vehicle-mounted device 3 is essentially a vehicle-mounted computer. The vehicle-mounted device 3 includes a storage device 31, at least one processor 32, a camera 34, a display screen 35, a positioning device 36, a direction indicator 37, and at least one sensor 38. The above listed components are electrically connected to each other.

Those skilled in the art should understand that the structure of the vehicle-mounted device 3 shown in FIG. 1 does not constitute a limitation of the embodiment of the present disclosure. The vehicle-mounted device 3 may further include more or less other hardware or software than that shown in FIG. 1, or the vehicle-mounted device 3 may have different component arrangements.

It should be noted that the vehicle-mounted device 3 is merely an example.

If another kind of vehicle-mounted devices can be adapted to the present disclosure, it should also be included in the protection scope of the present disclosure, and incorporated herein by reference.

In some embodiments, the storage device 31 may be used to store program codes and various data of computer programs. For example, the storage device 31 may be used to store a driving assistant system 30 and a high-precision map 39 installed in the vehicle-mounted device 3, and implement high-speed and automatic completion of storing programs or data during operation of the vehicle-mounted device 3. The storage device 31 may include Read-Only Memory (ROM), Programmable Read-Only Memory (PROM), and Erasable Programmable Read-Only Memory (EPROM), One-time Programmable Read-Only Memory (OTPROM), Electronically-Erasable Programmable Read-Only Memory (EEPROM), Compact Disc Read-Only Memory (CD-ROM) or other optical disk storage, disk storage, magnetic tape storage, or any other non-transitory computer-readable storage medium that can be used to carry or store data.

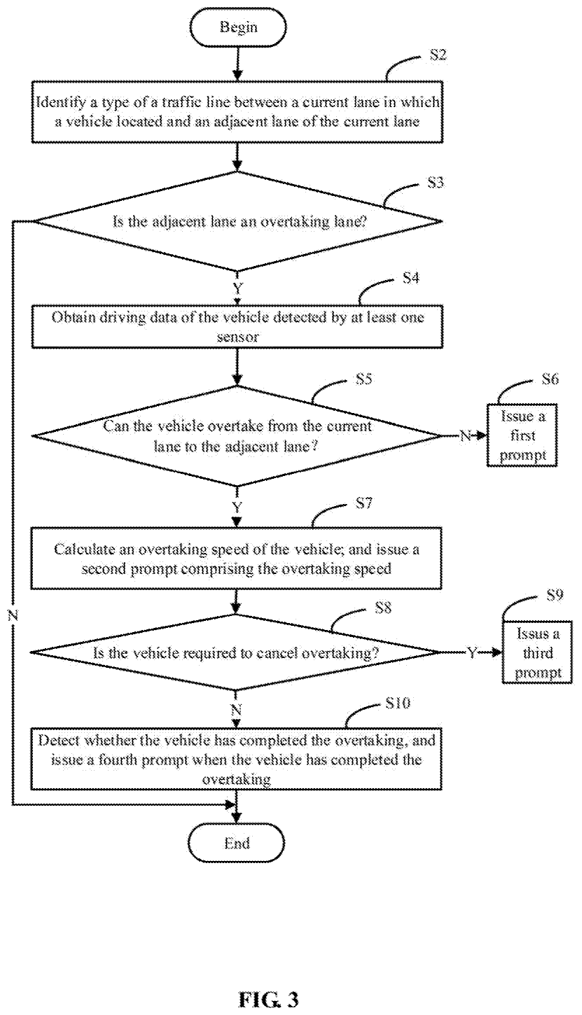

In some embodiments, the at least one processor 32 may be composed of an integrated circuit. For example, the at least one processor 32 can be composed of a single packaged integrated circuit, or multiple packaged integrated circuits with same function or different function. The at least one processor 32 includes one or more central processing units (CPUs), one or more microprocessors, one or more digital processing chips, one or more graphics processors, and various control chips. The at least one processor 32 is a control unit of the vehicle-mounted device 3. The at least one processor 32 uses various interfaces and lines to connect various components of the vehicle-mounted device 3, executes programs or modules or instructions stored in the storage device 31, and invokes data stored in the storage device 31 to perform various functions of the vehicle-mounted device 3 and process data, for example, perform a function of assisting overtaking for the vehicle 100 (for details, see the description of FIG. 3).

In this embodiment, the camera 34 can be installed at any position on the vehicle 100 where there the camera 34 can capture images of a traffic line between a lane in which the vehicle 100 is currently located and a lane adjacent to the lane in which the vehicle 100 is currently located. For example, the camera 34 can be installed at a position where a front windshield of the vehicle 100 is located. In this embodiment, to clearly describe the present disclosure, the lane in which the vehicle 100 is currently located is hereinafter referred to as “current lane”, and the lane adjacent to the lane in which the vehicle 100 is currently located is hereinafter referred to as “adjacent lane”. In this embodiment, the adjacent lane can be a left lane adjacent to the current lane (hereinafter, the left lane adjacent to the current lane is referred to as “left adjacent lane”), or the adjacent lane can be a right lane adjacent to the current lane (hereinafter, the right lane adjacent to the current lane is referred to as “right adjacent lane”).

It should be noted that different countries have different traffic regulations. Some countries use a left-hand traffic (LHT) as a driving direction, and other countries use a right-hand traffic (RHT) as the driving direction. The left-hand traffic can be defined to be keeping to the left side of the road. The right-hand traffic can be defined to be keeping to the right side of the road. Therefore, when the driving direction refers to the right-hand traffic, if the vehicle 100 drives in a single carriageway having two lanes with different directions, and the vehicle 100 overtakes from the left adjacent lane, the driving behavior is namely a reverse overtaking. Conversely, when the driving direction refers to the left-hand traffic, and if the vehicle 100 overtakes from the right adjacent lane, the driving behavior is also namely the reverse overtaking.

In this embodiment, the traffic line refers to a line at an edge of a lane that indicates traffic information such as guidance, restrictions, warnings, etc. to drivers. It should be noted that the traffic line with different types indicates different information. For example, according to the traffic regulation, when the type of the traffic line on a left side of the lane in which the vehicle 100 is currently located is a dashed type, i.e., the traffic line on the left side of the current lane is a dashed line, it means that the left adjacent lane can be used as an overtaking lane of the vehicle 100, and the vehicle 100 can change the lane from the current lane to the left adjacent lane. In the embodiment, the overtaking lane can be defined as a lane used to overtake a preceding vehicle. The preceding vehicle can be defined as a vehicle driving in the same lane as the vehicle 100, and in front of the vehicle 100.

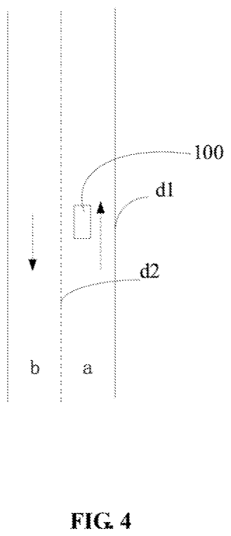

For another example, when the type of the traffic line on a right side of the current lane is a solid type, i.e., the traffic line on the right side of the current lane is a solid line, it means that the right adjacent lane cannot be used as the overtaking lane of the vehicle 100, and the vehicle 100 cannot change the lane from the current lane to the right adjacent lane. For example, referring to FIG. 4, a traffic line d1 on a right side of a current lane “a” is a solid line, and a traffic line d2 on a left side of the current lane “a” is a dashed line (that is, the traffic line d2 between the current lane “a” and a lane “b” is the dashed line), then the lane “b” can be used as the overtaking lane of the vehicle 100 located in the current lane “a”, and the vehicle 100 can change the lane from the current lane “a” to the lane “b”.

The display screen 35 may be a touch display screen for displaying various data of the vehicle-mounted device 3, such as a user interface of the high-precision map 39. In this embodiment, the high-precision map 39 may be a map such as a BAIDU high-precision map or other maps such as a GOOGLE high-precision map.

In this embodiment, the high-precision map 39 indicates all roads, all lanes of each road, the traffic line on a left side of each lane, the traffic line on a right side of each lane, the type of each traffic line, and the like.

In this embodiment, the positioning device 36 can be used to locate a current position (such as longitude and latitude information) of the vehicle 100. In one embodiment, the positioning device 36 can be a Global Positioning System (GPS), an Assisted Global Positioning System (AGPS), a BeiDou Navigation Satellite System (BDS), a global navigation satellite system (GLONASS), or a combination thereof.

The direction indicator 37 warns other vehicles and pedestrians to pay attention to the vehicle 100 when the direction indicator 37 is turned on. In detail, when the direction indicator 37 is turned on, the direction indicator 37 flashes to indicate that the vehicle 100 is turning left or right. The direction indicator 37 includes a left turn signal light and a right turn signal light. When the left turn signal light is turned on, the left turn signal light flashes to indicate that the vehicle 100 is turning left. When the right turn signal light is turned on, the right turn signal light flashes to indicate that the vehicle 100 is turning right.

The at least one sensor 38 can be a radar sensor.

In this embodiment, the driving assistant system 30 may include one or more modules. The one or more modules are stored in the storage device 31, and executed by at least one processor (e.g. the at least one processor 32 in this embodiment), such that a function of assisting overtaking for the vehicle 100 (for details, see the introduction to FIG. 3 below) is achieved.

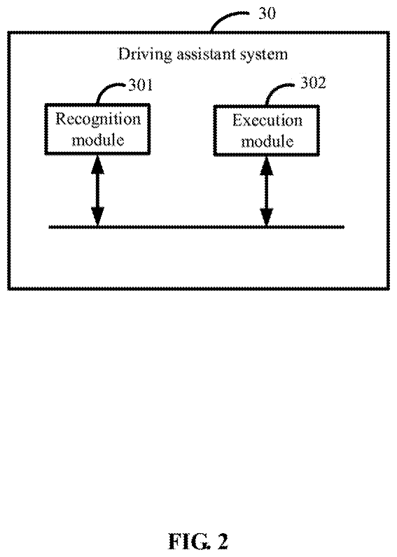

In this embodiment, the driving assistant system 30 may include a plurality of modules. Referring to FIG. 2, the plurality of modules includes a recognition module 301, and an execution module 302. The module referred in the present disclosure refers to a series of computer-readable instructions that can be executed by at least one processor (for example, the at least one processor 32), can complete fixed functions, and can be stored in a storage device (for example, the storage device 31 of the vehicle-mounted device 3). In this embodiment, the functions of each of the modules will be described in detail with reference to FIG. 3.

In this embodiment, an integrated unit implemented in a form of a software functional module can be stored in a non-transitory readable storage medium. The above listed modules include one or more computer-readable instructions. The vehicle-mounted device 3 or a processor implements the one or more computer-readable instructions, such that the method for assisting overtaking for the vehicle 100 shown in FIG. 3 is achieved.

In a further embodiment, referring to FIG. 2, the at least one processor 32 can execute an operating system of the vehicle-mounted device 3, various types of applications (such as the driving assistant system 30 described above), program codes, and the like.

In a further embodiment, the storage device 31 stores program codes of a computer program, and the at least one processor 32 can invoke the program codes stored in the storage device 31 to achieve related functions. For example, each of the modules of the driving assistant system 30 shown in FIG. 2 is a program code stored in the storage device 31. Each of the modules of the driving assistant system 30 shown in FIG. 2 is executed by the at least one processor 32, such that the functions of the modules are achieved, and a purpose of assisting overtaking for the vehicle 100 (see the description of FIG. 3 below for details) is achieved.

In one embodiment of the present disclosure, the storage device 31 stores one or more computer-readable instructions, and the one or more computer-readable instructions are executed by the at least one processor 32 to achieve a purpose of assisting overtaking for the vehicle 100. Specifically, the computer-readable instructions executed by the at least one processor 32 to achieve the purpose of assisting overtaking for the vehicle 100 is described in detail in FIG. 3 below.

FIG. 3 is a flowchart of an driving assistant method according to a preferred embodiment of the present disclosure.

In this embodiment, the driving assistant method can be applied to the vehicle-mounted device 3. For the vehicle-mounted device 3 that requires to assist overtaking for a vehicle, the vehicle-mounted device 3 can be directly integrated with the function of assisting overtaking. The vehicle-mounted device 3 can also achieve the function of assisting overtaking by running a Software Development Kit (SDK).

Referring to FIG. 3, the method is provided by way of example, as there are a variety of ways to carry out the method. The method described below can be carried out using the configurations illustrated in FIG. 1, for example, and various elements of these figures are referenced in the explanation of the method. Each block shown in FIG. 3 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The method can begin at block S2.

At block S2, when the vehicle 100 travels on a road, the recognition module 301 identifies a type of a traffic line between a lane in which the vehicle 100 is currently located and a lane adjacent to the lane in which the vehicle 100 is currently located.

As mentioned above, the lane in which the vehicle 100 is currently located is referred to as “current lane”, and the lane adjacent to the lane in which the vehicle 100 is currently located is referred to as “adjacent lane”. In one embodiment, the adjacent lane of the current lane can be the left adjacent lane, or the right adjacent lane.

In one embodiment, the recognition module 301 can identify the type of the traffic line between the current lane and the adjacent lane of the current lane by using the high-precision map 39.

As mentioned above, the high-precision map 39 indicates all roads, all lanes of each road, the traffic line of the left side of each lane, the traffic line of the right side of each lane, the type of each traffic line, and the like.

In one embodiment, the identifying of the type of the traffic line between the current lane and the adjacent lane of the current lane includes locating the current lane on the high-precision map 39 using the positioning device 36, and obtaining the type of the traffic line from the high-precision map 39.

In other embodiments, the identifying of the type of the traffic line between the current lane and the adjacent lane of the current lane includes capturing an image using the camera 34, where the captured image includes the traffic line between the current lane and the adjacent lane of the current lane, and identifying the type of the traffic line using an image recognition algorithm.

In this embodiment, the camera 34 can be installed at any position on the vehicle 100 where there the camera 34 can capture images of the traffic line between the current lane and the adjacent lane of the current lane. For example, the camera 34 can be installed at the position where the front windshield of the vehicle 100 is located.

In this embodiment, the image recognition algorithm includes a template matching method. The recognition module 301 can preset images including traffic lines with different types as templates. For example, the recognition module 301 can preset an image including a traffic line with a dashed type as a template, and an image including a traffic line with a solid type as a template. The recognition module 301 can match the captured image with each of the preset templates. When the captured image matches with a certain template, the recognition module 301 can determine that the type of the traffic line included in the captured image is same to the type of the certain template. That is, the type of the traffic line between the current lane and the adjacent lane of the current lane is determined. The certain template can be any one of the preset templates.

In other embodiments, the recognition module 301 can identify the type of the traffic line between the current lane and the adjacent lane of the current lane when the adjacent lane of the current lane is identified as a reverse-direction lane. The reverse-direction lane can be defined as a lane of which a direction is reverse to a direction of the current lane.

In one embodiment, the recognition module 301 identifies whether the adjacent lane is the reverse-direction lane.

In one embodiment, the identifying of whether the adjacent lane is the reverse-direction lane includes locating the current lane on the high-precision map 39 using the positioning device 36, and obtaining from the high-precision map 39 whether the adjacent lane of the current lane is the reverse-direction lane. The high-precision map 39 indicates that the adjacent lane of the current lane is the reverse-direction lane or a same-direction lane. The same-direction lane can be defined as a lane of which a direction is same to the direction of the current lane.

At block S3, the execution module 302 determines whether the adjacent lane of the current lane is an overtaking lane based on the type of the traffic line. When the adjacent lane of the current lane is the overtaking lane, the process goes to block S4.

In this embodiment, when the type of the traffic line is a dashed type, the execution module 302 determines that the adjacent lane is the overtaking lane. When the type of the traffic line is a solid type, the execution module 302 determines that the adjacent lane is not the overtaking lane. It should be noted that which type of the traffic line representing that the lane is the overtaking lane is determined according to the traffic regulations.

At block S4, when the adjacent lane is the overtaking lane, the execution module 302 obtains driving data of the vehicle 100 detected by the at least one sensor 38.

In this embodiment, the at least one sensor 38 can be the radar sensor.

In this embodiment, the driving data of the vehicle 100 may include, but is not limited to, a distance between the vehicle 100 and a preceding vehicle, and a speed of the vehicle 100 relative to the preceding vehicle. The preceding vehicle can be defined as a vehicle driven in the same lane as the vehicle 100, and in front of the vehicle 100.

In other embodiments, the execution module 302 may also obtain the driving data of the vehicle 100 based on the image captured by the camera 34.

At block S5, the execution module 302 estimates whether the vehicle 100 can overtake from the current lane to the adjacent lane based on the driving data of the vehicle 100. When the vehicle 100 cannot overtake from the current lane to the adjacent lane, the process goes to block S6. When the vehicle 100 can overtake from the current lane to the adjacent lane, the process goes to block S7.

In one embodiment, the estimating of whether the vehicle 100 can overtake from the current lane to the adjacent lane based on the driving data of the vehicle 100 includes inputting the driving data of the vehicle 100 into a pre-trained overtaking model, where the overtaking model includes a mapping relationship between different driving data and different overtaking results. For example, the overtaking model includes a relationship between driving data “A” and an overtaking result of overtaking successfully. The overtaking model further includes a relationship between driving data “B” and an overtaking result of overtaking unsuccessfully. In other words, the overtaking model can output a result of whether the vehicle 100 can overtake successfully based on the driving data of the vehicle 100.

In this embodiment, the overtaking model is trained based on a large amount of historical driving data collected from a number of overtaking. The overtaking model can be trained by the execution module 302. For example, the execution module 302 can collect a preset number (such as 100,000 copies) of sample data, and each of the sample data includes driving data collected during an overtaking and a corresponding overtaking result (i.e., overtaking successfully or unsuccessfully). The execution module 302 can train a neural network using the preset number of sample data, thereby obtaining the overtaking model.

It should be noted that the method of training of a neural network using a preset number of sample data to obtain a model is an existing technology which will not be repeated here.

At block S6, when the vehicle 100 cannot overtake from the current lane to the adjacent lane, the execution module 302 issues a first prompt. For example, the first prompt may refer to prompt a driver of the vehicle 100 that the vehicle 100 overtaking from the current lane to the adjacent lane is risky, by displaying text information on the display screen 35.

At block S7, when the vehicle 100 can overtake from the current lane to the adjacent lane, the execution module 302 calculates an overtaking speed of the vehicle 100. The execution module 302 may also issue a second prompt, the second prompt includes the overtaking speed. For example, the execution module 302 may prompt the driver the overtaking speed on the display screen 35 or prompt the driver the overtaking speed using voice. In one embodiment, the second prompt further includes prompting the driver of the vehicle 100 to turn on the direction indicator 37.

In one embodiment, the overtaking speed is V₂, where V₂²=V₁²+2as. V₁ represents a current speed of the vehicle 100, “a” represents a preset acceleration, and “s” represents a preset distance that the vehicle 100 needs to travel during overtaking, “s” is a preset value. It should be noted that a value of “a” can be determined according to a large number (for example, 10,000) of accelerations, the large number of accelerations are collected from a number of successful overtaking cases. The value of “a” can be equal to an average value of the large number of accelerations. The value of “s” can be determined according to a large number (for example, 10,000) of driving distances collected from a large number of successful overtaking cases. In one embodiment, “s” can be equal to an average value of the large number of driving distances. In one embodiment, each of the large number of driving distances can be a distance value from the vehicle 100 changes the lane from the current lane to the adjacent lane and then returns from the adjacent lane to the current lane.

At block S8, the execution module 302 detects whether an other vehicle drives in a reversing direction in the adjacent lane using at least one sensor 38. When the other vehicle is detected, the execution module 302 can determine whether the vehicle 100 is required to cancel overtaking based on a comparison between a detected distance value and a preset safety distance value. The detected distance value can be a distance value between the other vehicle driving in the reversing direction in the adjacent lane and the vehicle. The detected distance value can be detected by the at least one sensor 38. When the vehicle 100 is required to cancel overtaking, the process goes to block S9. When the vehicle 100 is not required to cancel overtaking, the process goes to block S10.

In one embodiment, the vehicle 100 detects the other vehicle when the vehicle 100 drives in the adjacent lane, the vehicle 100 detects the other vehicle using the at least one sensor 38. Specifically, the execution module 302 can determine whether the vehicle 100 drives in the adjacent lane by using the positioning device 36 and the high-precision map 39.

In one embodiment, when the detected distance value is greater than the preset safety distance value, the execution module 302 can determine that the vehicle 100 is not required to cancel overtaking. When the detected distance value is less than or equal to the preset safety distance value, the execution module 302 can determine that the vehicle 100 is required to cancel overtaking.

In this embodiment, the preset safety distance value can be an empirical value. In this embodiment, the preset safety distance value can be determined according to a number (for example, 10,000) of collected distance values. The number of collected distance values are collected from a number of successful overtaking cases. Each of the number of collected distance values represents a distance value between a vehicle driving in a current lane and a vehicle driving in the reversing direction in the adjacent lane in each of the successful overtaking cases. For example, the preset safety distance value can be equal to an average value of the number of collected distance values.

At block S9, when the vehicle 100 is required to cancel overtaking, the execution module 302 issues a third prompt. The third prompt can refer to prompt the driver of the vehicle 100 to terminate the overtaking by displaying text information on the display screen 35 or by voice announcement.

In other embodiments, when the vehicle 100 is required to cancel the overtaking, the execution module 302 also controls the vehicle 100 to decelerate, thereby facilitating the driver of the vehicle 100 to control the vehicle 100 to return to an original lane (the original lane is the current lane that is described in block S1, i.e., the original lane is a lane in which the vehicle 100 is driven before the vehicle 100 is driven in the overtaking lane).

At block S10, when the vehicle 100 is not required to cancel the overtaking, the execution module 302 further detects whether the vehicle 100 has completed the overtaking. When the vehicle 100 has completed the overtaking, the execution module 302 issues a fourth prompt, the fourth prompt includes prompting the driver of the vehicle 100 to turn off the direction indicator 37.

In one embodiment, the execution module 302 can detect whether the vehicle 100 has completed the overtaking by using the positioning device 36 and the high-precision map 39. In one embodiment, when the vehicle 100 travels from the current lane to the adjacent lane of the current lane and then from the adjacent lane of the current lane to the current lane, the execution module 302 determines that the vehicle 100 has completed overtaking.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A driving assistant method applied to a vehicle-mounted device, the method comprising:
identifying a type of a traffic line between a current lane in which a vehicle located and an adjacent lane of the current lane;
determining whether the adjacent lane is an overtaking lane based on the type of the traffic line;
obtaining driving data of the vehicle detected by at least one sensor when the adjacent lane is the overtaking lane;
estimating whether the vehicle can overtake from the current lane to the adjacent lane based on the driving data of the vehicle;
calculating an overtaking speed of the vehicle when the vehicle can overtake from the current lane to the adjacent lane; and
issuing a prompt comprising the overtaking speed.

2. The method according to claim 1, further comprising:
detecting whether an other vehicle drives in a reversing direction in the adjacent lane using the at least one sensor;
determining whether the vehicle is required to cancel overtaking based on a comparison between a detected distance value and a preset safety distance value, wherein the detected distance value is a distance value between the other vehicle driving in the reversing direction in the adjacent lane and the vehicle; and
issuing a prompt when the vehicle is required to cancel overtaking.

3. The method according to claim 1, wherein the step of identifying of the type of the traffic line between the current lane and the adjacent lane of the current lane comprises:
locating the current lane on a high-precision map using a positioning device; and
obtaining the type of the traffic line from the high-precision map.

4. The method according to claim 1, wherein the step of identifying of the type of the traffic line between the current lane and the adjacent lane of the current lane comprises:
capturing an image using at least one camera, wherein the captured image comprises the traffic line between the current lane and the adjacent lane of the current lane; and
identifying the type of the traffic line using an image recognition algorithm.

5. The method according to claim 1, wherein the driving data of the vehicle comprises a distance between the vehicle and a preceding vehicle, and a speed of the vehicle relative to the preceding vehicle.

6. The method according to claim 5, wherein the step of estimating whether the vehicle can overtake from the current lane to the adjacent lane based on the driving data of the vehicle comprises:
inputting the driving data of the vehicle into a pre-trained overtaking model, wherein the pre-trained overtaking model comprises a mapping relationship between different driving data and different overtaking results, the pre-trained overtaking model outputs a result of whether the vehicle can overtake successfully based on the driving data of the vehicle.

7. The method according to claim 1, wherein the overtaking speed is V₂, wherein V₂²=V₁²+2as; V₁ represents a current speed of the vehicle; “a” represents a preset acceleration; “s” represents a preset distance that the vehicle needs to travel during overtaking.

8. A vehicle-mounted device comprising:
a storage device; and
at least one processor;
wherein the storage device stores one or more programs, which when executed by the at least one processor, cause the at least one processor to:
identify a type of a traffic line between a current lane in which a vehicle located and an adjacent lane of the current lane;
determine whether the adjacent lane is an overtaking lane based on the type of the traffic line;
obtain driving data of the vehicle detected by at least one sensor when the adjacent lane is the overtaking lane;
estimate whether the vehicle can overtake from the current lane to the adjacent lane based on the driving data of the vehicle;
calculate an overtaking speed of the vehicle when the vehicle can overtake from the current lane to the adjacent lane; and
issue a prompt comprising the overtaking speed.

9. The vehicle-mounted device according to claim 8, wherein the at least one processor is further caused to:
detect whether an other vehicle drives in a reversing direction in the adjacent lane using the at least one sensor;
determine whether the vehicle is required to cancel overtaking based on a comparison between a detected distance value and a preset safety distance value, wherein the detected distance value is a distance value between the other vehicle driving in the reversing direction in the adjacent lane and the vehicle; and
issue a prompt when the vehicle is required to cancel overtaking.

10. The vehicle-mounted device according to claim 8, wherein the step of identifying the type of the traffic line between the current lane and the adjacent lane of the current lane comprises:
locating the current lane on a high-precision map using a positioning device; and
obtaining the type of the traffic line from the high-precision map.

11. The vehicle-mounted device according to claim 8, wherein the step of identifying the type of the traffic line between the current lane and the adjacent lane of the current lane comprises:
capturing an image using at least one camera, wherein the captured image comprises the traffic line between the current lane and the adjacent lane of the current lane; and
identifying the type of the traffic line using an image recognition algorithm.

12. The vehicle-mounted device according to claim 8, wherein the driving data of the vehicle comprises a distance between the vehicle and a preceding vehicle, and a speed of the vehicle relative to the preceding vehicle.

13. The vehicle-mounted device according to claim 12, wherein the step of estimating whether the vehicle can overtake from the current lane to the adjacent lane based on the driving data of the vehicle comprises:
inputting the driving data of the vehicle into a pre-trained overtaking model, wherein the pre-trained overtaking model comprises a mapping relationship between different driving data and different overtaking results, the pre-trained overtaking model outputs a result of whether the vehicle can overtake successfully based on the driving data of the vehicle.

14. The vehicle-mounted device according to claim 8, wherein the overtaking speed is V₂, wherein V₂²=V₁²+2as; V₁ represents a current speed of the vehicle; “a” represents a preset acceleration; “s” represents a preset distance that the vehicle needs to travel during overtaking.

15. A non-transitory storage medium having instructions stored thereon, when the instructions are executed by a processor of a vehicle-mounted device, the processor is configured to perform an driving assistant method, wherein the method comprises:
identifying a type of a traffic line between a current lane in which a vehicle located and an adjacent lane of the current lane;
determining whether the adjacent lane is an overtaking lane based on the type of the traffic line;
obtaining driving data of the vehicle detected by at least one sensor when the adjacent lane is the overtaking lane;
estimating whether the vehicle can overtake from the current lane to the adjacent lane based on the driving data of the vehicle;
calculating an overtaking speed of the vehicle when the vehicle can overtake from the current lane to the adjacent lane; and
issuing a prompt comprising the overtaking speed.

16. The non-transitory storage medium according to claim 15, wherein the method further comprises:
detecting whether an other vehicle drives in a reversing direction in the adjacent lane using the at least one sensor;
determining whether the vehicle is required to cancel overtaking based on a comparison between a detected distance value and a preset safety distance value, wherein the detected distance value is a distance value between the other vehicle driving in the reversing direction in the adjacent lane and the vehicle; and
issuing a prompt when the vehicle is required to cancel overtaking.

17. The non-transitory storage medium according to claim 15, wherein the step of identifying the type of the traffic line between the current lane and the adjacent lane of the current lane comprises:
locating the current lane on a high-precision map using a positioning device; and
obtaining the type of the traffic line from the high-precision map.

18. The non-transitory storage medium according to claim 15, wherein the step of identifying the type of the traffic line between the current lane and the adjacent lane of the current lane comprises:
capturing an image using at least one camera, wherein the captured image comprises the traffic line between the current lane and the adjacent lane of the current lane; and
identifying the type of the traffic line using an image recognition algorithm.

19. The non-transitory storage medium according to claim 15, wherein the driving data of the vehicle comprises a distance between the vehicle and a preceding vehicle, and a speed of the vehicle relative to the preceding vehicle.

20. The non-transitory storage medium according to claim 19, wherein the step of estimating whether the vehicle can overtake from the current lane to the adjacent lane based on the driving data of the vehicle comprises:
inputting the driving data of the vehicle into a pre-trained overtaking model, wherein the pre-trained overtaking model comprises a mapping relationship between different driving data and different overtaking results, the pre-trained overtaking model outputs a result of whether the vehicle can overtake successfully based on the driving data of the vehicle.
